(19) United States
(12) Patent Application Publication
(10) Pub. No.: US 2014/0067883 A1
(43) Pub. Date: Mar. 6, 2014

(54) FILE PROCESSING APPARATUS FOR FILE TRANSFER, FILE PROCESSING METHOD, AND STORAGE MEDIUM

(71) Applicant: CASIO COMPUTER CO., LTD., Tokyo (JP)

(72) Inventor: Ken FUJITA, Tokyo (JP)

(73) Assignee: CASIO COMPUTER CO., LTD., Tokyo (JP)

(21) Appl. No.: 14/015,382

(22) Filed: Aug. 30, 2013

(30) Foreign Application Priority Data
Aug. 31, 2012 (JP) 2012-191914

(51) Int. Cl. G06F 17/30

(52) U.S. Cl. CPC G06F 17/3007
USPC 707/821

(57) ABSTRACT

The object of the present invention is to secure the identity of a file even if the file name has been changed. The image capture apparatus 1 includes: a captured image generation unit (81); a file name generation unit (82); and an image file generation unit (83). The captured image generation unit (81) generates data of a captured image and a normal file name of the file. The file name generation unit (82) generates a transfer destination file name corresponding to a predetermined transfer destination to which a file generated by the captured image generation unit (81) is transferred. The image file generation unit (83) adds a transfer destination file name generated by the file name generation unit (82) to the file as additional information and stores the file in the image file storage unit 62.

This application is based on and claims the benefit of priority from Japanese Patent Application No. 2012-191914, filed on 31 Aug. 2012, the content of which is incorporated herein by reference.

### BACKGROUND OF THE INVENTION

1. Field of the Invention

The present invention relates to a file processing apparatus, a file processing method, and storage medium.

2. Related Art

Data files stored in one's apparatus are often transferred to another apparatus. When transferring data files from one's own apparatus to another apparatus, the names of data files in one's own apparatus may sometimes overlap names of data files in the other apparatus. For such cases, a technology is disclosed in Japanese Unexamined Patent Application, Publication No. 2005-33710, for example, which prioritizes the sustaining of existing data files over incoming data files in another apparatus that is a transfer destination, changes names of data files being transferred and saves as files with different names.

### SUMMARY OF THE INVENTION

A file processing apparatus according to a first aspect of the present invention includes:

a file generation unit that generates a file consisting of data and a first file name of the file; a file name identification unit that identifies a second file name that is different from the first file name corresponding to a predetermined transfer destination to which the file generated by the file generation unit is transferred; and a addition unit that adds the second file name identified by the file name identification unit to the file as additional information.

A file processing method according to a second aspect of the present invention includes:

a file generation step of generating a file consisting of data and a first file name of the file; a file name identification step of identifying a second file name that is different from the first file name corresponding to a predetermined transfer destination to which the file generated in the file generation step is transferred; and a addition step of adding the second file name identified in the file name identification step to the file as additional information.

A storage medium encoded with a computer-readable program according to the third aspect of the present invention is:

a storage medium encoded with a computer-readable program that enables a file processing apparatus to execute: a file generation function that generates a file consisting of data and a first file name of the file; a file name identification function that identifies a second file name that is different from the first file name corresponding to a predetermined transfer destination to which the file generated by the file generation function is transferred; and a addition function that adds the second file name identified by the file name identification function to the file as additional information.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a schematic diagram showing a general outline of an image capture apparatus according to an embodiment of a file processing apparatus of the present invention;

FIG. 2 is a schematic diagram showing a file configuration of an image file;

FIG. 3 is a block diagram showing a hardware configuration of an image capture apparatus according to an embodiment of the present invention;

FIG. 4 is a functional block diagram showing a functional configuration for executing file management processing among the functional configurations of the image capture apparatus of FIG. 3;

FIG. 5 is a functional block diagram showing a functional configuration for executing file generation processing among the functional configurations of the image capture apparatus of FIG. 3;

FIG. 6 is a functional block diagram showing a functional configuration for executing file transfer processing among the functional configurations of the image capture apparatus of FIG. 3;

FIG. 7 is a functional block diagram showing a functional configuration for executing identical file determination processing among the functional configurations of the image capture apparatus of FIG. 3;

FIG. 8 is a flowchart illustrating a flow of file management processing executed by the image capture apparatus of FIG. 3 having the functional configuration of FIG. 4;

FIG. 9 is a flowchart illustrating a flow of file generation processing executed by the image capture apparatus of FIG. 3 having the functional configuration of FIG. 5;

FIG. 10 is a flowchart illustrating a flow of file transfer processing executed by the image capture apparatus of FIG. 3 having the functional configuration of FIG. 6; and

FIG. 11 is a flowchart illustrating a flow of identical file determination processing executed by the image capture apparatus of FIG. 3 having the functional configuration of FIG. 7.

### DETAILED DESCRIPTION OF THE INVENTION

In the following, embodiments of the present invention are described with reference to the drawings.

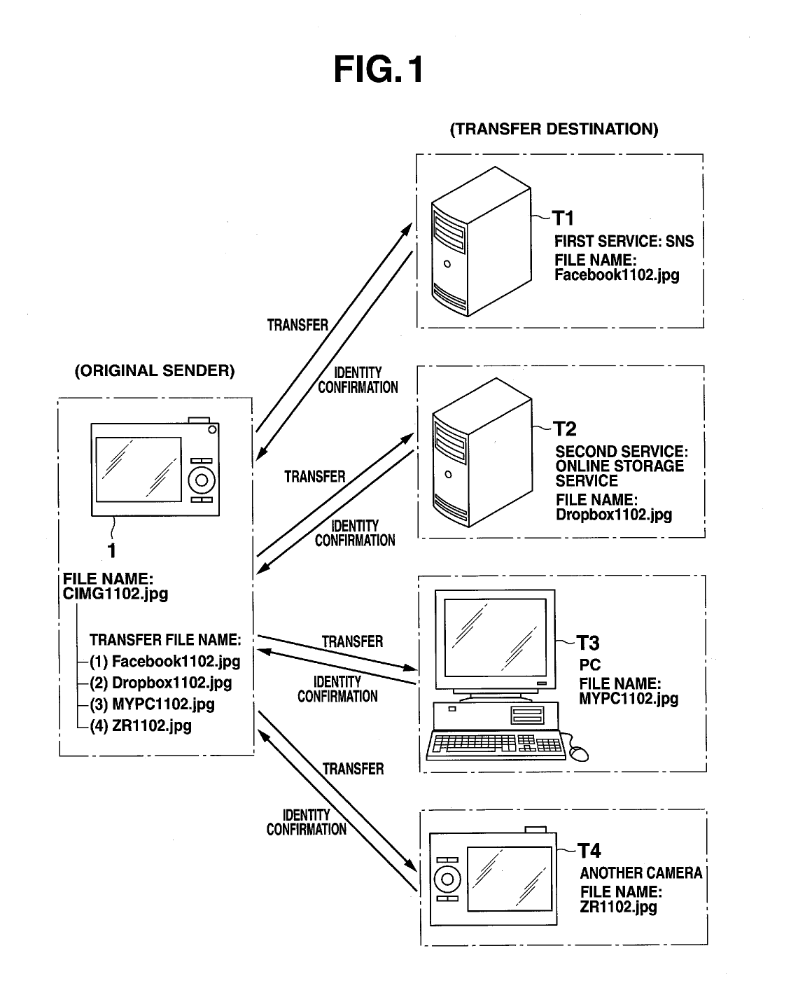

FIG. 1 is a schematic diagram showing a general outline of an image capture apparatus 1 according to an embodiment of a file processing apparatus of the present invention.

As shown in FIG. 1, an image capture apparatus 1 transfers an image file acquired by image capturing to predetermined external apparatuses T1 to T4.

Various types of external apparatuses T1 to T4 as transfer destinations can include: a server apparatus T1 that can transfer files via a network provided by an SNS service (Social Networking Service) as a first service; a server apparatus T2 that can transfer files via a network provided by an online storage service as a second service; a PC (personal computer) T3 that can transfer files via storage media, etc.; and another image capture apparatus (hereinafter, referred to as “another camera”) T4 that can transfer files via storage media, etc. It should be noted that the present embodiment is described with the examples of the first service as Facebook™ and the second service as Dropbox™.

It should also be noted that the various types of external apparatuses T1 to T4 are referred to as simply “external apparatus T” in the following when it is unnecessary to distinguish those from each other.

In addition, upon file transfer, the image capture apparatus 1 changes a file name of a file being transferred to a name that is appropriate for a transfer destination.

The file name appropriate for the transfer destination is not created upon file transfer, but rather created upon generating an image file and sustained in the image file with a file name for transfer (hereinafter, referred to as “transfer file name”). In addition, a file name corresponding to a transfer destination may be a name that can be identified and judged by a user and may be acceptable so long as at least the image capture apparatus 1 that transfers can identify a transfer destination.

As described above, an image file transferred by the image capture apparatus 1 sustains information of the two file names of a file name that is actually a file name for an image file (hereinafter, referred to as “normal file name”) and a transfer file name that is a transfer file name corresponding to a transfer destination. It should be noted that, upon generating an image file, a file name that is named in accordance with a rule specific to the image capture apparatus 1 is given to the image file as a normal file name.

More specifically, at the time of generating an image file, “CIMG1102.jpg” is given for a normal file name. Furthermore, for a transfer file name, “Facebook1102.jpg” is given for the first service, “Dropbox1102.jpg” is given for the second service, “MYPC1102.jpg” is given for PC, and “ZR1102.jpg” is given for another camera.

It should be noted that, although a rule is set above in which a transfer file name is given by combining a type of a transfer destination and a date when a file is generated in the present embodiment, the present invention is not limited thereto and can name the transfer file according to various rules.

The external apparatus T to which the files are transferred stores an image file from the image capture apparatus 1. Furthermore, the external apparatus T performs an identity confirmation request for confirming whether the files stored are those from the image capture apparatus 1 that is an original sender, with respect to the capture image apparatus 1.

The image capture apparatus 1 that receives the identify confirmation request retrieves an image file stored and determines whether there are files identical to the files at the transfer destination. Then, the image capture apparatus 1 displays a result of the determination on its own display means and notifies to a user by transmitting to the external apparatus T.

Therefore, in the present embodiment, since it is possible to confirm the identity by the method as described above, even if a file name were changed upon file transfer, it is possible to secure the identity of the file.

Next, the file configuration of an image file generated by the image capture apparatus 1 as described above is described.

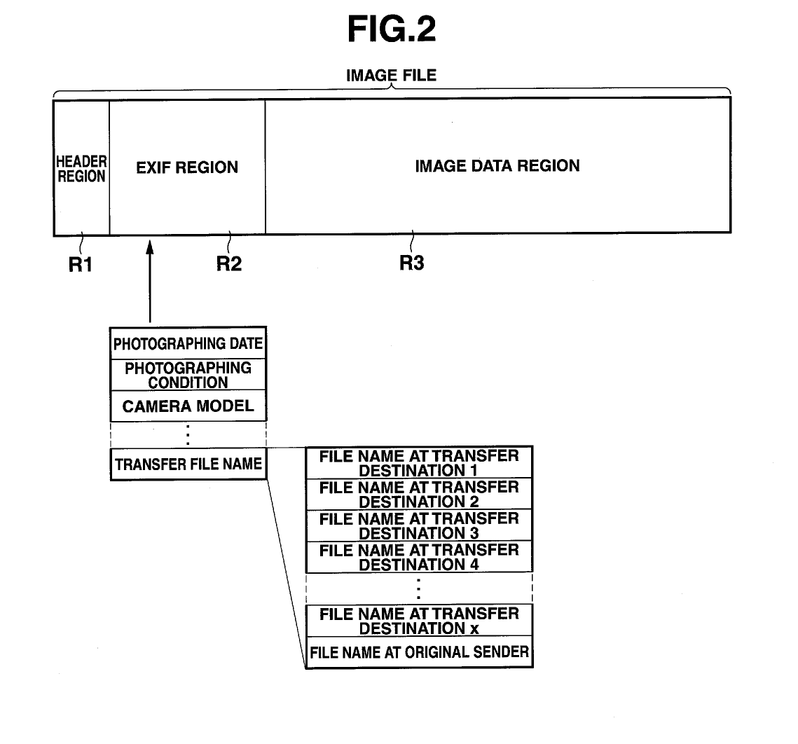

FIG. 2 is a schematic diagram showing a file configuration of an image file.

An image file is generated in compliance with the Exif (Exchangeable image file format) image file standard.

As shown in FIG. 2, this image file includes a header region R1, an Exif region R2, and an image data region R3.

As shown in FIG. 1, more specifically, the header region R1 is a region in which various pieces of header information such as CIMG1102.jpg are stored.

The Exif region R2 is a region in which metadata of an image is stored. More specifically, in the Exif region R2, information of photographing date, information of photographing conditions such as aperture value, information of camera model, thumbnail, and the like are stored.

Furthermore, in the Exif region R2, transfer file names (file names from the transfer destination 1 to the transfer destination x, and a file name of the original sender) are stored along with the information of the Exif standard as described above. More specifically, as shown in FIG. 1, the transfer file names are: transfer destination (1) Facebook1102.jpg; transfer destination (2) Dropbox1102.jpg; transfer destination (3) MYPC1102.jpg; transfer destination (4) MYPC1102.jpg; and CIMG1102.jpg, a file name when generating an image file (normal file name).

By configuring so as to store the transfer file names in the Exif region R2 in this way, a transfer file name can be sustained in an existing region without defining a new region. In other words, the transfer file names can be sustained without needing to change a way of generating an image file previously and the transfer file names can also be sustained for the existing image files as well.

Next, a hardware configuration of the aforementioned such image capture apparatus 1 is described.

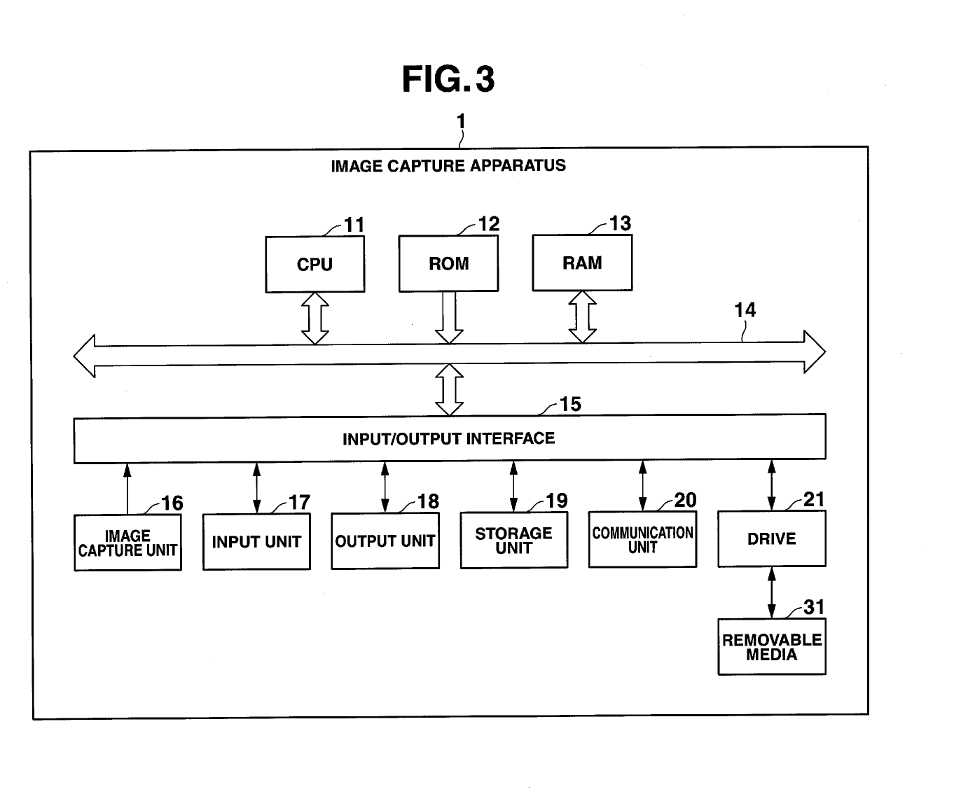

FIG. 3 is a block diagram showing a hardware configuration of the image capture apparatus 1 according to an embodiment of the present invention.

The image capture apparatus 1 is configured as, for example, a digital camera.

The image capture apparatus 1 includes a CPU (Central Processing Unit) 11, ROM (Read Only Memory) 12, RAM (Random Access Memory) 13, bus 14, an Input/Output interface 15, an image capture unit 16, an input unit 17, an output unit 18, a storage unit 19, a communication unit 20, and a drive 21.

The CPU 11 executes various processing according to programs that are recorded in the ROM 12, or programs that are loaded from the storage unit 19 to the RAM 13.

The RAM 13 also stores data and the like necessary for the CPU 11 to execute the various processing, as appropriate.

The CPU 11, the ROM 12 and the RAM 13 are connected to one another via the bus 14. The input/output interface 15 is also connected to the bus 14. The image capture unit 16, the input unit 17, the output unit 18, the storage unit 19, the communication unit 20, and the drive 21 are connected to the input/output interface 15.

The image capture unit 16 includes an optical lens unit and an image sensor (not shown).

In order to photograph a subject, the optical lens unit is configured by a lens such as a focus lens and a zoom lens for condensing light.

The focus lens is a lens for forming an image of a subject on the light receiving surface of the image sensor. The zoom lens is a lens that causes the focal length to freely change in a certain range.

The optical lens unit also includes peripheral circuits to adjust setting parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device. The optoelectronic conversion device optoelectronically converts (i.e. captures) the image of the subject, accumulates the resultant image signal for a predetermined time interval, and sequentially supplies the image signal as an analog signal to the AFE.

The AFE executes a variety of signal processing such as A/D (Analog/Digital) conversion processing of the analog signal. The variety of signal processing generates a digital signal that is output as an output signal from the image capture unit 16.

Such an output signal of the image capture unit 16 is hereinafter referred to as “data of a captured image”. Data of a captured image is supplied to the CPU 11 as necessary.

The input unit 17 is configured by various buttons and inputs a variety of information in accordance with instruction operations by the user.

The output unit 18 is configured by the display unit, a speaker, and the like, and outputs images and sound.

The storage unit 19 is configured by hard disk or DRAM (Dynamic Random Access Memory) or the like, and stores data of various images.

The communication unit 20 controls communication with other devices (not shown) via networks including the Internet.

A removable medium 31 composed of a magnetic disk, an optical disk, a magneto-optical disk, semiconductor memory or the like is installed in the drive 21, as appropriate. Programs that are read via the drive 21 from the removable medium 31 are installed in the storage unit 19, as necessary. Similarly to the storage unit 19, the removable medium 31 can also store a variety of data such as the image data stored in the storage unit 19.

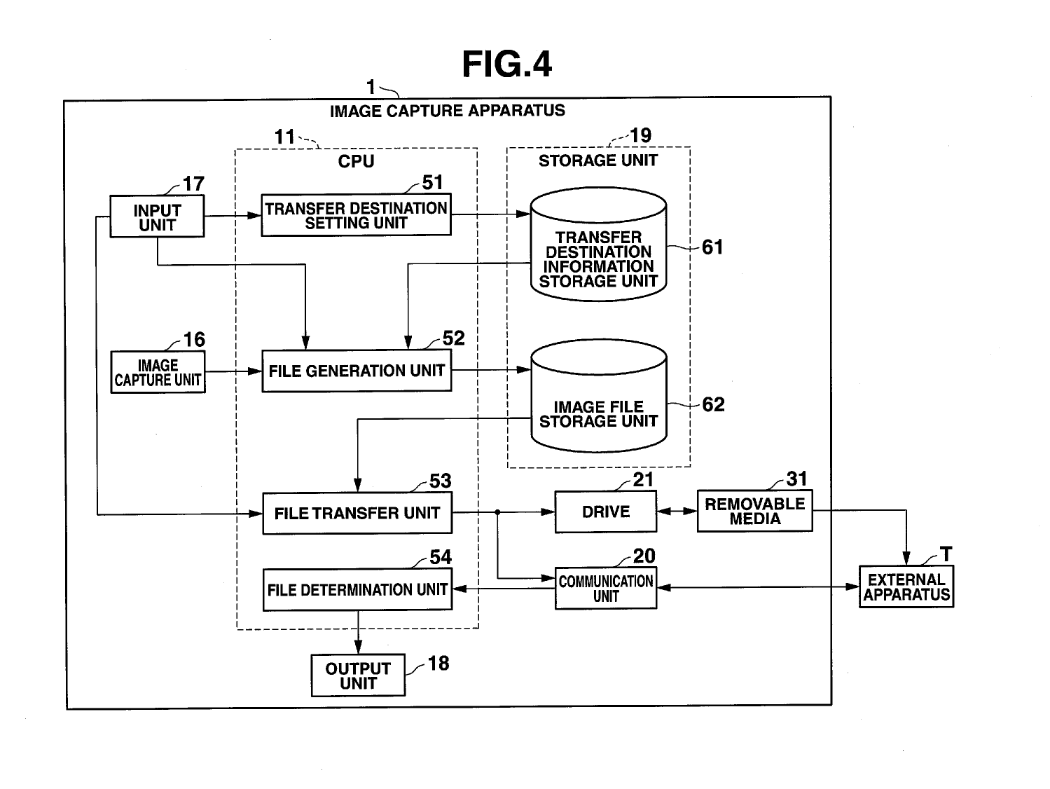

FIG. 4 is a functional block diagram showing a functional configuration for executing file management processing among the functional configurations of the image capture apparatus 1 of FIG. 3.

The file management processing refers to a sequence of processing of sustaining a file name for an image file acquired, for each transfer destination and in a case of having confirmed as identical, confirming the image file stored and notifying.

In a case of executing the file management processing, as shown in FIG. 4, a transfer destination setting unit 51, a file generation unit 52, a file transfer unit 53, and a file determination unit 54 function in the CPU 11.

It should be noted that the matter of the transfer destination setting unit 51 through the file determination unit 54 functioning in the CPU 11 is merely an example. That is to say, at least a part of the functions of the transfer destination setting unit 51 through the file determination unit 54 can be assumed by other constituent elements other than the CPU 11 (for example, a processor dedicated to image processing (not shown)).

A region of the storage unit 19 is provided with a transfer destination information storage unit 61 and an image file storage unit 62.

Information relating to a transfer set by the transfer destination setting unit 51 (hereinafter, referred to as “transfer destination information”) is stored in the transfer destination information storage unit 61. The transfer destination information includes, for example, information of a transfer destination, a transfer method, a naming rule for naming a file to be changed upon transfer, and the like.

An image file generated by the file generation unit 52 is stored in the image file storage unit 62.

The transfer destination setting unit 51 outputs transfer destination information to the transfer destination information storage unit 61 based on an operation relating to setting of a transfer destination from the input unit 17 (hereinafter, referred to as “transfer destination setting operation”) and sets a transfer destination. In the present embodiment, the transfer destination setting unit 51 sets the four transfer destinations of the first service of SNS: Facebook™, the second service of the online storage service: Dropbox™, PC, and another camera.

It can also be configured so that a file is automatically transferred to a transfer destination set or a file can be transferred to any transfer destination selected from among the transfer destinations set.

The file generation unit 52 performs file generation processing based on an operation for generating a file from the input unit 17, i.e. an operation of instructing image capturing and recording (hereinafter, referred to as “image capturing recording instruction operation”) in the present embodiment which generates an image file.

The “file generation processing” refers to a sequence of processing of giving a normal file name to data of a captured image acquired from the image capture unit 16, and further sustaining a transfer file name to generate an image file.

It should be noted that the details of the file generation unit 52 are described later.

The file transfer unit 53 performs file transfer processing based on an operation for transferring a file from the input unit 17 (hereinafter, referred to as “transfer instruction operation”).

The “file transfer processing” refers to a sequence of processing of changing a file name to a name corresponding to a predetermined transfer destination to transfer the file based on transfer destination information stored in the transfer destination information storage unit 61.

It should be noted that the details of the file transfer unit 53 are described later.

The file determination unit 54 performs file determination processing based on an instruction for performing determination of an identical file in order to confirm the identity of a file from the external apparatus T (hereinafter, referred to as “identity determination instruction”).

The “file determination processing” refers to a sequence of processing of retrieving a corresponding file name from image files stored in the image file storage unit 62, and notifying a determination result.

It should be noted that the details of the file determination unit 54 are described later.

Next, the details of the file generation unit 52 are described.

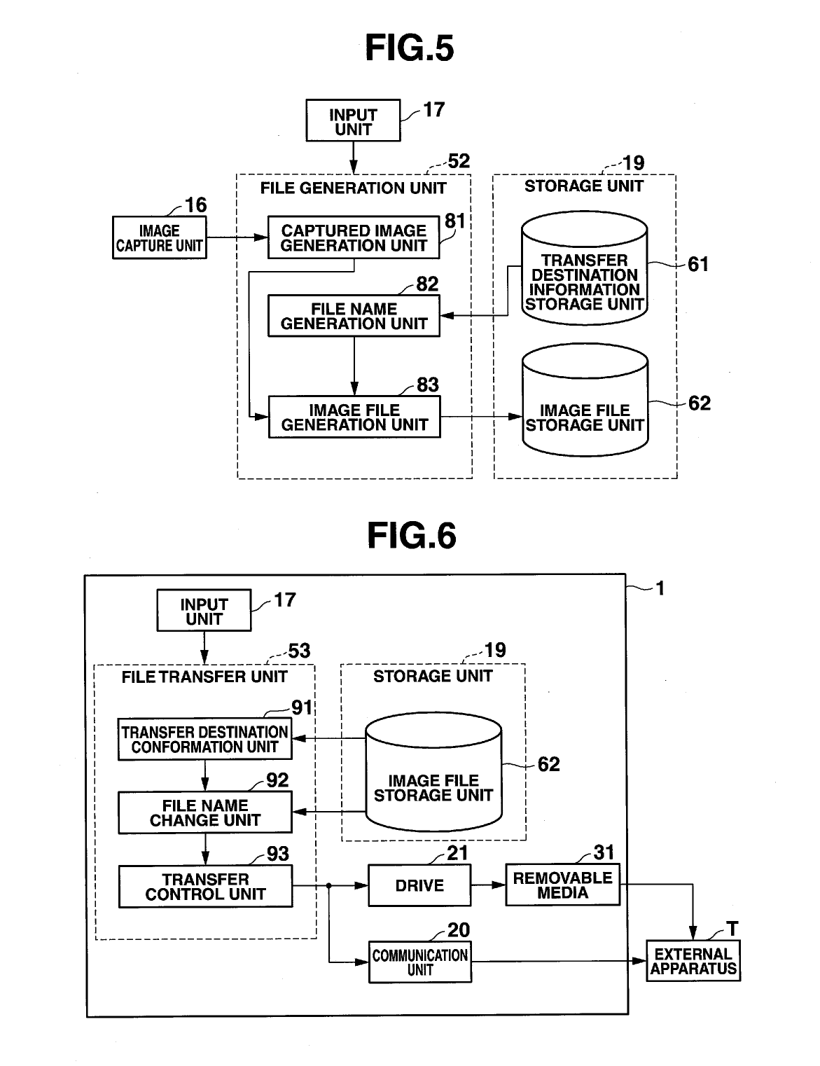

FIG. 5 is a functional block diagram showing a functional configuration for executing file generation processing among the functional configurations of the image capture apparatus 1 of FIG. 3.

In a case of executing the file generation processing, as shown in FIG. 5, a captured image generation unit 81, a file name generation unit 82, and an image file generation unit 83 function in the file generation unit 52.

The captured image generation unit 81 acquires data of a captured image from the image capture unit 16 and gives a normal file name to the data of the captured image. Regarding the normal file name given by the captured image generation unit 81, a file name that can be identified by the apparatus that it is generated by the apparatus (for example, “CIMG1102.jpg” in the present embodiment) is given.

The captured image generation unit 81 outputs data of a captured image to which a file name is given to the image file generation unit 83.

The file name generation unit 82 generates a file name for a transfer destination for each transfer destination based on a transfer destination set, i.e. transfer destination information stored in the transfer destination information storage unit 61.

The file name generation unit 82 generates transfer file names corresponding to the four transfer destinations set (the first service of Facebook™, the second service of Dropbox™, PC, and another camera).

The file name generation unit 82 generates a transfer file name of “Facebook1102.jpg” based on a rule of service name of transfer destination+generated date, for the first service of Facebook™.

The file name generation unit 82 generates a transfer file name of “Dropbox1102.jpg” based on a rule of service name of transfer destination+generated date, for the second service of Dropbox™.

The file name generation unit 82 generates a transfer file name of “MYPC1102.jpg” based on a rule of type of transfer destination+generated date, for PC.

The file name generation unit 82 generates a transfer file name of “ZR1102.jpg” based on a rule of model name of another camera of transfer destination, for another camera.

The file name generation unit 82 outputs information of a transfer file name generated to the image file generation unit 83.

The image file generation unit 83 adds information of a transfer file name generated by the file name generation unit 82 to the Exif region of data of a captured image to which a normal file name outputted from the captured image generation unit 81 is given so as to generate an image file.

The image file generation unit 83 outputs an image file generated to the image file storage unit 62.

The details of the file generation unit 52 are described above.

Next, the details of the file transfer unit 53 are described.

FIG. 6 is a functional block diagram showing a functional configuration for executing file transfer processing among the functional configurations of the image capture apparatus 1 of FIG. 3.

In a case of executing the file transfer processing, as shown in FIG. 6, a transfer destination confirmation unit 91, a file name change unit 92, and a transfer control unit 93 function in the file transfer unit 53.

The transfer destination confirmation unit 91 confirms a transfer file name of an image file to be transferred to confirm a transfer destination or confirms a transfer destination based on a transfer instruction.

The transfer destination confirmation unit 91 outputs the transfer destination confirmed to the file name change unit 92.

The file name change unit 92 changes a file name of an image file duplicated and extracted for transfer based on a transfer file name that an image file sustains.

In a case of the transfer destination being the first service, the file name change unit 92 changes the normal file name of “CIMG1102.jpg” to a transfer file name of the first service of “Facebook1102.jpg”.

In a case of the transfer destination being the second service, the file name change unit 92 changes the normal file name of “CIMG1102.jpg” to the transfer file name of the second service of “Dropbox1102.jpg”.

In a case of the transfer destination being PC, the file name change unit 92 changes the normal file name of “CIMG1102.jpg” to the transfer file name of PC of “MYPC1102.jpg”.

In a case of the transfer destination being another camera, the file name change unit 92 changes the normal file name of “CIMG1102.jpg” to the transfer file name of another camera of “ZR1102.jpg”.

The transfer control unit 93 transfers an image file with a transfer method according to the transfer destinations.

In a case of the transfer destination being the first service, the transfer control unit 93 transfers an image file to a server of the first service via the communication unit 20.

In a case of the transfer destination being the second service, the transfer control unit 93 transfers an image file to a server of the second service via the communication unit 20.

In a case of the transfer destination being PC, the transfer control unit 93 transfers an image file to the removable media 31 via the drive 21. Subsequently, it is transferred to the PC by a user via the removable media 31.

In a case of the transfer destination being another camera, the transfer control unit 93 transfers an image file to the removable media 31 via the drive 21. Subsequently, it is transferred to another camera by a user via the removable media 31.

The details of the file transfer unit 53 are described above.

Next, the details of the file determination unit 54 are described.

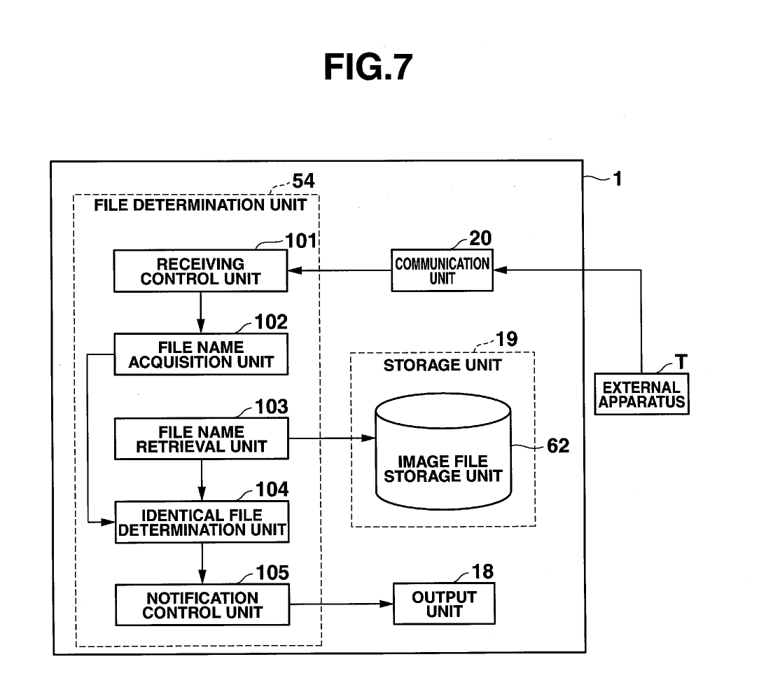

FIG. 7 is a functional block diagram showing a functional configuration for executing identical file determination processing among the functional configurations of the image capture apparatus 1 of FIG. 3.

As shown in FIG. 6, in a case of executing the identical file determination processing, a receiving control unit 101, a file name acquisition unit 102, a file name retrieval unit 103, an identical file determination unit 104, and a notification control unit 105 function in the file determination unit 54.

The receiving control unit 101 receives an identity determination instruction from the external apparatus T via the communication unit 20. It should be noted that the identity determination instruction includes a file as a determination target and a file name as a determination target along with simply an instruction for requesting the identify conformation.

The file name acquisition unit 102 acquires a file name as a determination target based on the identity determination instruction received from the receiving control unit 101. The file name acquisition unit 102 acquires a file name as a determination target from a file or a file name as a determination target included in the identity determination instruction.

The file name retrieval unit 103 retrieves a transfer file name stored in the Exif region of an image file stored in the image file storage unit 62.

The identical file determination unit 104 compares a transfer file name that is a retrieved result of the file name retrieval unit 103 with a file name as a determination target acquired by the file name acquisition unit 102 so as to determine whether these are identical files. The identical file determination unit 104 outputs a determination result to the notification control unit 105.

The notification control unit 105 outputs for display a determination result from the identical file determination unit 104 to the output unit 18 and outputs it to the external apparatus T via the communication unit 20.

According to the control of the notification control unit 105, a determination result of the presence or absence of an identical file is output and displayed at the output unit 18 to be notified to a user.

The details of the file determination unit 54 are described above.

Next, a detailed flow of the file management processing is described.

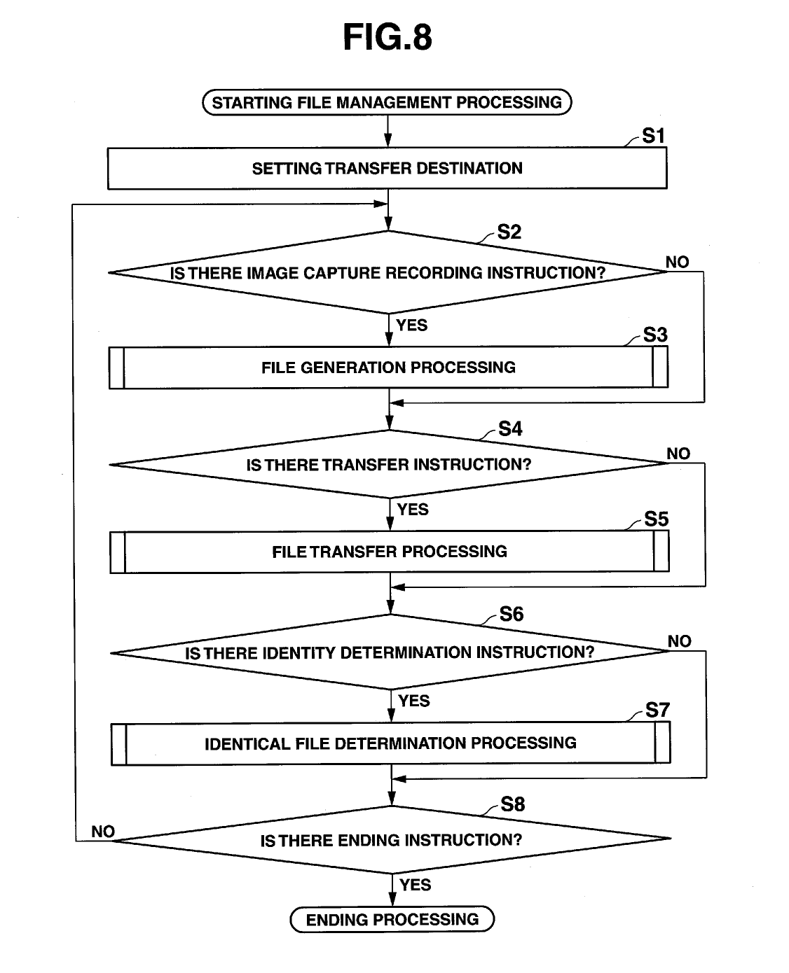

FIG. 8 is a flowchart illustrating a flow of the file management processing executed by the image capture apparatus 1 of FIG. 3 having the functional configuration of FIG. 4.

The file management processing starts upon an operation of starting file management processing on the input unit 17 by a user.

In Step S1, the transfer destination setting unit 51 performs setting of a transfer destination. More specifically, based on a transfer destination setting operation which is an operation for setting a transfer destination on the input unit 17 by the user, the transfer destination setting unit 51 performs setting of a transfer destination by storing information relating to a transfer destination in the transfer destination information storage unit 61. In the present embodiment, the transfer destinations of the first service, the second service, PC, and another camera are set. Transfer methods according to the transfer destinations are set along with the transfer destinations. For the first service and the second service, a transfer method is selected by way of a network such as the Internet via the communication unit 20. For PC and another camera, a transfer method via the removable media 31 is selected, for example.

In Step S2, the file generation unit 52 determines whether there is an instruction for performing image capturing and recording (hereinafter, referred to as “image capturing and recording instruction”). More specifically, the file generation unit 52 determines whether the image capturing and recording instructing operation is performed on the input unit 17 such as a shutter button.

In a case in which it is determined that there is no image capturing recording instruction, a NO determination is made in Step S2 and the processing advances to Step S4. The processing of Step S4 and later is described later.

In a case in which it is determined that there is an image capturing recording instruction, a YES determination is made in Step S2 and the processing advances to Step S3.

In Step S3, the file generation unit 52 performs file generation processing. The details of the file generation processing are described later.

In Step S4, the file transfer unit 53 determines whether there is an instruction for transferring a file to a predetermined transfer destination (hereinafter, referred to as “transfer instruction”).

More specifically, the file transfer unit 53 determines whether the transfer instruction operation was performed on the input unit 17 such as a shutter button.

In a case in which it is determined that there is no transfer instruction, a NO determination is made in Step S4 and the processing advances to Step S6. The processing of Step S6 and higher is described later.

In a case in which it is determined that there is a transfer instruction, a YES determination is made in Step S4 and the processing advances to Step S5.

In Step S5, the file transfer unit 53 performs file transfer processing. The details of the file transfer processing are described later.

In Step S6, the file determination unit 54 determines whether there is an identity determination instruction from the external apparatus T.

In a case in which there is no identity determination instruction, a NO determination is made in Step S6 and the processing advances to Step S8. The processing of Step S8 and higher is described later.

In a case in which there is an identity determination instruction, a YES determination is made in Step S6 and the processing advances to Step S7.

In Step S7, the file determination unit 54 performs the identity file determination processing.

In Step S8, the CPU 11 determines whether there was an end instruction of the file management processing.

In a case in which there is no end instruction, a NO determination is made in Step S8 and the processing returns back to Step S2 and enters a standby state for various instructions such as the image capturing and recording instruction.

In a case in which there is an end instruction, a YES determination is made in Step S8 and the processing ends. Then, the file management processing ends.

The detailed flow of the file management processing is described above.

Next, the detailed flow of file generation processing in the file management processing is described.

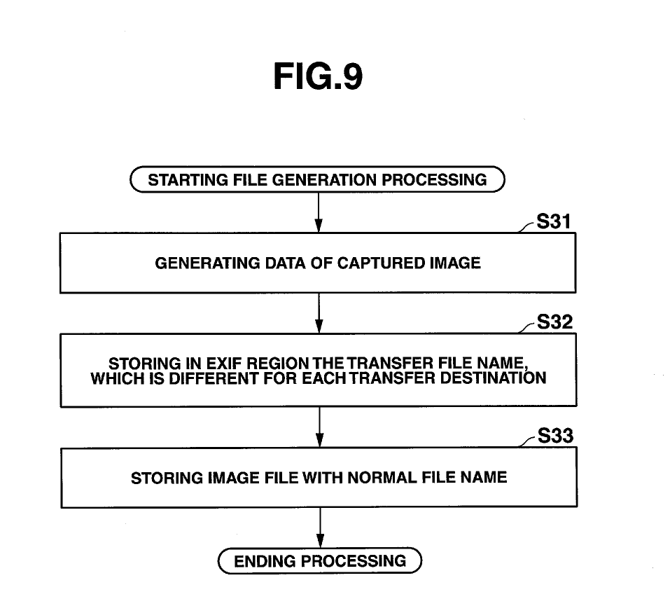

FIG. 9 is a flowchart illustrating a flow of file generation processing executed by the image capture apparatus 1 of FIG. 3 having the functional configuration of FIG. 5.

In Step S31, the captured image generation unit 81 generates data of a captured image. More specifically, the captured image generation unit 81 compresses data to a data format such as JPEG (Joint Photographic Experts Group), for example, and generates data of a captured image based on data of an image acquired from the image capture unit 16.

In Step S32, the file name generation unit 82 stores transfer file names, which are different for each transfer destination, in the Exif region. More specifically, the file name generation unit 82 generates a transfer file name based on a transfer destination information stored in the transfer destination information storage unit 61 and adds file names, which are different for each transfer destination, in a predetermined empty region of an image file generated by the captured image generation unit 81 (Exif region in the present embodiment).

The image file stored in the image file storage unit 62 sustains information of a normal file name and a transfer file name generated.

In Step S33, the image file generation unit 83 stores an image file with a normal file name. More specifically, the image file generation unit 83 gives a normal file name, which is a apparatus-specific file name, to data of a captured image to which information of a transfer file name is added in Step S32, and stores the image file in the image file storage unit 62.

Then, the file generation processing ends.

The detailed flow of the file generation processing is described above.

The detailed flow of file transfer processing is described below.

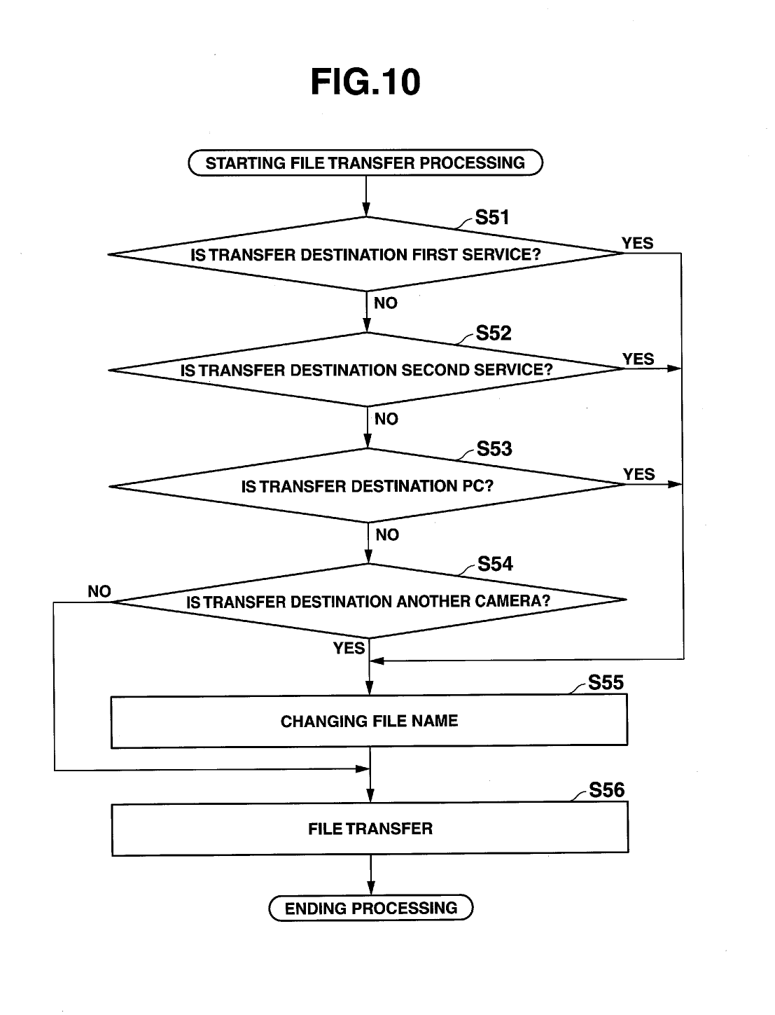

FIG. 10 is a flowchart illustrating a flow of file transfer processing executed by the image capture apparatus 1 of FIG. 3 having the functional configuration of FIG. 6.

In Step S51, the transfer destination confirmation unit 91 confirms whether it is a transfer destination stored in the transfer destination information storage unit 61, i.e. determines whether a transfer destination is the first service. In other words, the transfer control unit 93 determines whether the transfer instruction of Step S4 is an instruction for transferring to the first service.

In a case in which it is determined that the transfer destination is the first service, a YES determination is made in Step S51 and the processing advances to Step S55. The processing of Step S55 and higher is described later.

In a case in which it is determined that the transfer destination is not the first service, a NO determination is made in Step S51 and the processing advances to Step S52.

In Step S52, the transfer destination confirmation unit 91 determines whether the transfer destination is the second service. In other words, the transfer destination confirmation unit 91 determines whether the transfer instruction of Step S4 is an instruction for transferring to the second service.

In a case in which it is determined that the transfer destination is the second service, a YES determination is made in Step S52 and the processing advances to Step S55.

In a case in which it is determined that the transfer destination is not the second service, a NO determination is made in Step S52 and the processing advances to Step S53.

In Step S53, the transfer destination confirmation unit 91 determines whether the transfer destination is PC. In other words, the transfer destination confirmation unit 91 determines whether the transfer instruction of Step S4 is an instruction for transferring to PC.

In a case in which it is determined that the transfer destination is PC, a YES determination is made in Step S53 and the processing advances to Step S55.

In a case in which it is determined that the transfer destination is not PC, a NO determination is made in Step S53 and the processing advances to Step S54.

In Step S54, the transfer destination confirmation unit 91 determines whether the transfer destination is another camera. In other words, the transfer destination confirmation unit 91 determines whether the transfer instruction of Step S4 is an instruction for transferring to another camera.

In a case in which it is determined that the transfer destination is another camera, a YES determination is made in Step S54 and the processing advances to Step S55.

In a case in which it is determined that the transfer destination is not another camera, a NO determination is made in Step S54 and the processing advances to Step S56. In this case, since the transfer instruction does not instruct transferring to the transfer destination set, the transferring of a file to a transfer destination designated by the instruction is performed. It should be noted that changing a file name is not performed in this case.

In Step S55, the file name change unit 92 changes the name to a file name according to the transfer destination. More specifically, the file name change unit 92 extracts the transfer file name according to the transfer destination determined in Step S51 to Step S54 from the Exif region of an image file, and changes the name of a normal file name to the name of a transfer file name of the transfer file thus extracted.

In Step S56, the transfer control unit 93 performs file transfer. More specifically, the transfer control unit 93 performs file transfer to a transfer destination designated by a transfer instruction, i.e. by a transfer method according to a transfer destination. More specifically, in a case in which the transfer destination is the first service and the second service, the transfer control unit 93 transfers a file to a server, etc. designated by each service through a network via the communication unit 20. Furthermore, in a case in which the transfer destination is PC, the transfer control unit 93 transfers a file to the removable media 31 or the like via the drive 21. Furthermore, in a case in which the transfer destination is another camera, the transfer control unit 93 transfers a file by way of the removable media 31 to which the file was transferred via the drive 21, for example.

It should be noted that, in a case in which a NO determination is made in Step S54, i.e. in a case in which a transfer is performed to a transfer destination that is not set, a file transfer is performed with a normal file name without changing the file name.

The file transfer processing thereby ends.

The detailed flow of the file transfer processing is described above.

The detailed flow of the identical file determination processing is described below.

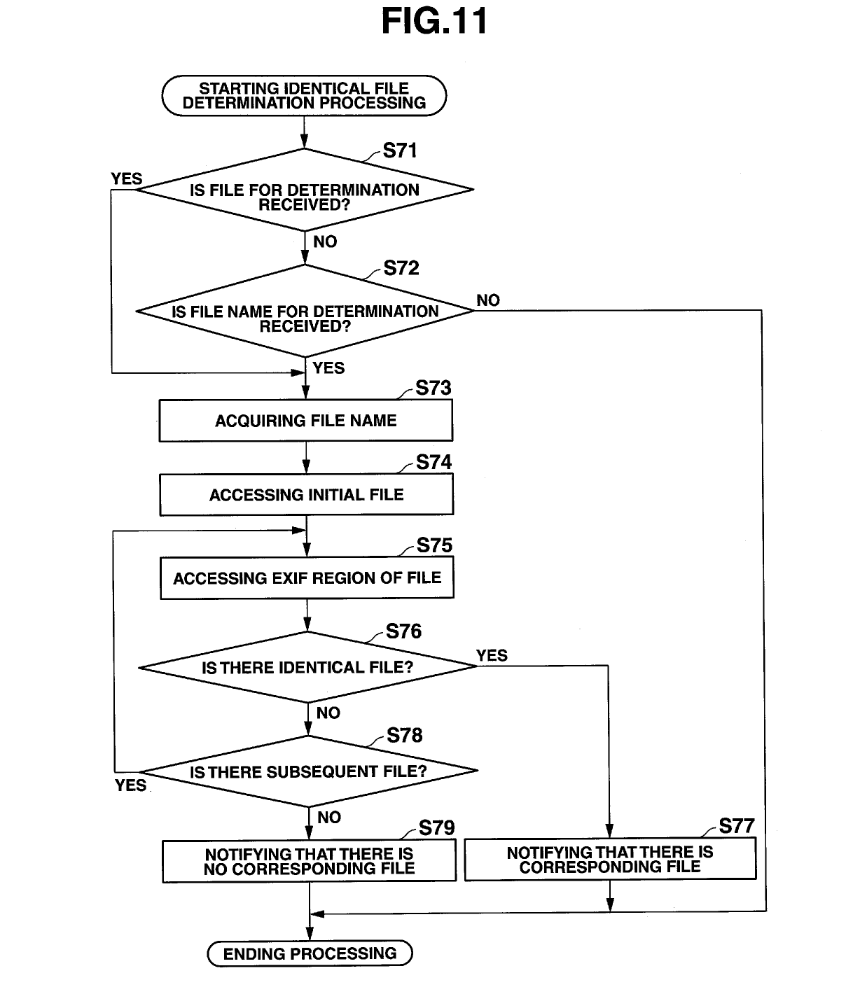

FIG. 11 is a flowchart illustrating a flow of identical file determination processing executed by the image capture apparatus 1 of FIG. 3 having the functional configuration of FIG. 7.

In Step S71, the receiving control unit 101 determines whether a file as a target for determining identity (hereinafter, referred to as “file for determination”) was received.

In a case in which the file for determination was not received, a NO determination is made in Step S71 and the processing advances to Step S72.

In Step S72, the receiving control unit 101 determines whether data of file name information of the file for determination was received.

In a case in which the data of file name information of the file for determination was not received, a NO determination is made in Step S72 and the identical file determination processing ends.

On the other hand, in a case in which a file name of a file for determination was received, a YES determination is made in Step S72 and the processing advances to Step S73.

On the other hand, in a case in which a file for determination was received, a YES determination is made in Step S71 and the processing advances to Step S73.

In Step S73, a file name acquisition unit 102 acquires a file name. More specifically, in a case of acquiring a file in Step S71, the file name acquisition unit 102 retrieves a file name from data of the file and acquires a file name for performing identity determination.

Furthermore, in a case of acquiring file name information in Step S72, the file name acquisition unit 102 acquires a file name from data of the file name information. The file name that the file name acquisition unit 102 acquires becomes a target for determining identity.

In Step S74, the file name retrieval unit 103 accesses an initial file within the image file storage unit 62. In the present embodiment, a plurality of image files is sequentially determined in the order of addresses. In the present step, an access is made to a file that is initially determined, based on the address.

In Step S75, the file name retrieval unit 103 accesses the Exif information. In other words, the file name retrieval unit 103 accesses the Exif region of the file accessed to acquire the Exif information in Step S74. Information relating to a file name such as a file name before change is stored in the Exif information.

In Step S76, the identical file determination unit 104 determines whether there is an identical file name. In other words, the identical file determination unit 104 compares a file name acquired in Step S73 with information relating to a file name stored in the Exif information acquired in Step S75 to determine whether there is an identical file name.

In a case in which there is an identical file name, a YES determination is made in Step S76 and the processing advances to Step S77.

In Step S77, the notification control unit 105 performs notifying that there is corresponding file. In other words, the notification control unit 105 controls the output unit 18 to notify that there is an identical file name (corresponding file), such as to output to display. As a result, a message of “there is an identical file” or the like is displayed on the output unit 18. Then, by viewing the output on the display unit 18, for example, the user performs an operation such as overwriting a file, deleting a file, changing a file name, or the like. Then, the identical file name determination processing ends.

On the other hand, in a case in which there is no identical file name, a NO determination is made in Step S76 and the processing advances to Step S78.

In Step S78, the file name retrieval unit 103 determines whether there is a subsequent file. In other words, the file name retrieval unit 103 searches for whether there is an image file that is not yet determined in the image file storage unit 62 in the order of address.

In a case in which there is a subsequent file, a YES determination is made in Step S78, and the processing returns back to Step S75, and the processing of Step S75 and later is performed. In other words, the determination for an identical file name is performed for image files stored in the subsequent addresses.

On the other hand, in a case in which it is determined that there is no corresponding file, a NO determination is made in Step S78 and the processing advances to Step S79.

In Step S79, the notification control unit 105 notifies that there is no corresponding file. In other words, the notification control unit 105 controls the output unit 18 to notify that there is no identical file name, for example, performs output such as to output to display. As a result, a message of “there is no identical file” or the like is displayed on the output unit 18. Then, by viewing the output on the display unit 18, for example, the user performs operations such as registering a file or the like. Subsequently, the identical file name determination processing ends.

The image capture apparatus 1 configured as described above includes: the captured image generation unit 81; the file name generation unit 82; and the image file generation unit 83.

The captured image generation unit 81 generates data of a captured image and a normal file name of the file.

The file name generation unit 82 generates (identifies) a transfer destination file name corresponding to a predetermined transfer destination to which a file generated (identified) by the captured image generation unit 81 is transferred.

The image file generation unit 83 associates a transfer destination with the transfer destination file name generated by the file name generation unit 82 to add to the file as additional information and to store in the image file storage unit 62.

Therefore, the image capture apparatus 1 associates a transfer destination with the transfer destination file name generated (identified) by the file name generation unit 82 to add to the file as additional information and to store in the image file storage unit 62.

Therefore, even in a case in which a file name is changed to a transfer destination file name and the file name becomes different from the file name at the time of generating the file, the image capture apparatus 1 can determine the file identity by confirming a sustained transfer destination file name since the file sustains the transfer destination file name.

Furthermore, the image capture apparatus 1 further includes the transfer control unit 93 and the file name change unit 92.

The transfer control unit 93 controls the communication unit 20, the drive 21, and the like so as to transfer a file to a transfer destination that is stored in additional information of a file.

Upon controlling to transfer a file to a transfer destination by the transfer control unit 93, the file name change unit 92 changes the file name of a file to be transferred to a file name which is stored to be associated with a transfer destination stored in additional information.

Therefore, in the image capture apparatus 1, file transfer can be performed by automatically changing a file name to an appropriate file name without additional steps according to a transfer destination.

Furthermore, in the image capture apparatus 1, it is possible to change a file name to a file name according to a transfer destination without needing to manage information relating to a file name by a storage means or the like.

Furthermore, in the image capture apparatus 1, the file name generation unit 82 generates (identifies) a file name according to a transfer destination upon a file being generated by the captured image generation unit 81. Furthermore, the image file generation unit 83 adds the transfer destination and the file name generated by the captured image generation unit 81 to the file as additional information.

Therefore, in the image capture apparatus 1, since the additional information relating to a transfer file name is added upon the image file being generated, the file size does not change subsequently. In other words, in a case of subsequently adding the transfer destination file name after the file being generated, the file size becomes different from the original file size; however, in the image capture apparatus 1, since the file size does not change from the original file, there is a merit such as enabling the managing of files systematically.

Furthermore, the image capture apparatus 1 further includes the transfer destination setting unit 51 that sets a transfer destination.

Furthermore, the file name generation unit 82 generates (identifies) a file name according to the transfer destination set by the transfer destination setting unit 51.

Therefore, it is possible to arbitrarily set a transfer destination in the image capture apparatus 1.

Furthermore, the file name generation unit 82 generates a transfer file name so as not to overlap a transfer file name previously generated.

Therefore, since it is configured such that the transfer file names generated are not overlapped in the image capture apparatus 1, it is possible to avoid overlapping file names at transfer destinations even if the file names are changed upon transfer.

Furthermore, the image capture apparatus 1 further includes the file name acquisition unit 102, the identical file determination unit 104, and the notification control unit 105.

The file name acquisition unit 102 acquires a file from a transfer destination or a file name of the file.

The identical file determination unit 104 determines whether the file name acquired by the file name acquisition unit 102 or the file name is included in additional information of any file stored in the image capture apparatus 1.

The notification control unit 105 notifies a determination result by the identical file determination unit 104 to the output unit 18 and the like.

Therefore, in the image capture apparatus 1, in a case in which a file of which transfer destination seems similar is acquired from another place, it is possible to determine whether the file is a file generated in the image capture apparatus 1.

Furthermore, the file used in the present embodiment is an image file and additional information of a transfer destination file name is stored in the Exif region within the transfer destination.

Therefore, it is possible to easily perform the transfer management of image files in the image capture apparatus 1.

It should be noted that the present invention is not to be limited to the aforementioned embodiment, and that modifications, improvements, etc. within a scope that can achieve the object of the present invention are also included in the present invention.

For example, in the embodiments described above, it is configured so that the transfer destination file name is generated upon generating an image file so as to be stored in the image file (the Exif region) in consideration of a subsequent increase in the file size of the image file.

However, the present invention is not limited thereto. It may be configured so that storing of the transfer destination file name to the image file (the Exif region) is performed at the time of transferring a file (or before transferring a file). In such a case, if it is configured so as to secure a predetermined region for storing a transfer destination file name upon generating an image file, the transfer destination file name can be stored in the image file (the Exif region) while the file size does not increase subsequently.

Furthermore, it may be configured so that the transfer destination file name is generated not only at the time of generating the image file, but also at the time of transferring a file (or before transferring a file). With such a configuration, since the transfer destination file name is not generated upon the image file being generated, it is possible to reduce processing load upon generating an image file.

Furthermore, in the embodiments described above, the external apparatus T to which the file is transferred from the image capture apparatus 1, which is an original sender, requests the identity determination without the file name changed. For example, it may be configured such that, in a case in which the file name is changed at the transfer destination, the change of the file name from the external apparatus T at the transfer destination is notified to the image capture deice 1, which is an original sender, and a file name that is newly changed is added or updated to the transfer destination file name of the corresponding file in the image capture apparatus 1 that is the original sender. With such a configuration, even in a case in which the file is changed at the transfer destination (the external apparatus T), if requesting the identity determination to the apparatus of the original sender (the image capture apparatus 1), it is possible to determine the identity since the data reflecting the change in file name is sustained therein.

Furthermore, in the embodiment described above, the identity of the files is determined between the image capture apparatus 1 and the external apparatus T, i.e. between a apparatus in which an image file is generated and an apparatus to which a file is transferred from the apparatus. However, the present invention is not limited thereto. It may be configured so that the determination of the identity of files is performed between external apparatuses (between the server apparatus T1 of the first service and PC T3) in the condition in which with files are transferred from an apparatus in which an image file is generated (the image capture apparatus 1), from the external apparatus to which a file is transferred (for example, the server apparatus T1 of the first service), and further to the external apparatus (for example, PC T3).

In addition, in the embodiment described above, the file used is an image file. However, the present invention is not limited thereto. For example, the file may be a moving image file, a document file, or the like, so long as the file is a file used when changing a file name to a file name different from a normal file name stored.

Furthermore, in the embodiment described above, although only the transfer destination file name is stored in the Exif region R2, it may be configured so as to be stored associated with the corresponding transfer destination.

In the aforementioned embodiments, a digital camera has been described as an example of the image capture apparatus 1 to which the present invention is applied; however, the present invention is not particularly limited thereto.

For example, the present invention can be applied to any electronic apparatus in general having a file management processing function. More specifically, for example, the present invention can be applied to a lap-top personal computer, a printer, a television, a video camera, a portable navigation apparatus, a cell phone apparatus, a portable gaming apparatus, and the like.

The processing sequence described above can be executed by hardware, and can also be executed by software.

In other words, the hardware configuration shown in FIG. 4 is merely an illustrative example, and the present invention is not particularly limited thereto. More specifically, the types of functional blocks employed to realize the above-described functions are not particularly limited to the example shown in FIG. 4, so long as the image capture apparatus 1 can be provided with the functions enabling the aforementioned processing sequence to be executed in its entirety.

A single functional block may be configured by a single piece of hardware, a single installation of software, or any combination thereof.

In a case in which the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium 31 shown in FIG. 3 distributed separately from the apparatus main body for supplying the program to a user, but also can be constituted by a storage medium or the like supplied to the user in a state incorporated in the apparatus main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), or the like. The magnetic optical disk is composed of an MD (Mini-Disk) or the like. The storage medium supplied to the user in a state incorporated in the apparatus main body in advance may include, for example, the ROM 12 shown in FIG. 3, a hard disk included in the storage unit 19 shown in FIG. 3 or the like, in which the program is recorded.

It should be noted that, in the present specification, the steps describing the program recorded in the storage medium include not only the processing executed in a time series following this order, but also processing executed in parallel or individually, which is not necessarily executed in a time series.

Although some embodiments of the present invention have been described above, the embodiments are merely exemplification, and do not limit the technical scope of the present invention. Other various embodiments can be employed for the present invention, and various modifications such as omission and replacement are possible without departing from the sprits of the present invention. Such embodiments and modifications are included in the scope of the invention and the summary described in the present specification, and are included in the invention recited in the claims as well as the equivalent scope thereof. While the present invention has been described with reference to the preferred embodiments, it is intended that the invention be not limited by any of the details of the description therein but includes all the embodiments which fall within the scope of the appended claims.

What is claimed is:

1. A file processing apparatus comprising:
a file generation unit that generates a file consisting of data and a first file name of the file;
a file name identification unit that identifies a second file name that is different from the first file name corresponding to a predetermined transfer destination to which the file generated by the file generation unit is transferred; and
a addition unit that adds the second file name identified by the file name identification unit to the file as additional information.

2. The file processing apparatus according to claim 1, further comprising:
a transferring unit that transfers the file to the transfer destination stored as the additional information; and
a file name change unit that, when the transferring unit transfers the file to the transfer destination, changes a first file name of a file to be transferred to a second file name corresponding to the transfer destination stored as the additional information.

3. The file processing apparatus according to claim 1,
wherein, when the file is generated by the file generation unit, the file name identification unit identifies a second file name corresponding to the transfer destination, and the addition unit adds the second file name identified by the file name identification unit as the additional information to the file.

4. The file processing apparatus according to claim 1,
wherein, after the file is generated by the file generation unit, the file name identification unit identifies a second file name corresponding to the transfer destination, and the addition unit adds a second file name identified by the file name identification unit as the additional information to the file.

5. The file processing apparatus according to claim 2,
wherein, when the transferring unit transfers the file to the transfer destination, the file name identification unit identifies a second file name corresponding to the transfer destination, and the addition unit adds the second file name identified by the file name identification unit as the additional information to the file.

6. The file processing apparatus according to claim 2,
wherein, when a change of a file name is notified from a transfer destination, the addition unit adds a file name having the change in the additional information as a second file name.

7. The file processing apparatus according to claim 1, further comprising:
a setting unit that sets the transfer destination, wherein
the file name identification unit identifies a second file name corresponding to a transfer destination set by the setting unit.

8. The file processing apparatus according to claim 1, wherein
the file name identification unit identifies a second file name so as not to overlap a second file name determined previously.

9. The file processing apparatus according to claim 1, further comprising:
an acquisition unit that acquires a file or a file name of the file from the transfer destination;
a determination unit that determines whether the file or the file name acquired by the acquisition unit is included in additional information of any file stored in the file processing apparatus; and
a notification unit that notifies a determination result by the determination unit.

10. The file processing apparatus according to claim 1, wherein
there is a plurality of the predetermined transfer destinations,
the file name identification unit identifies a second file name that is different from the first file name corresponding to each of the plurality of the predetermined transfer destinations; and
the addition unit adds a plurality of second file names identified by the file name identification unit as additional information to the file.

11. The file processing apparatus according to claim 1, wherein
the addition unit adds to the file additional information further associating the transfer destination with the second file name.

12. The file processing apparatus according to claim 1, wherein
the file is an image and the additional information is Exif (Exchangeable image file format) information.

13. A file processing method comprising:
a file generation step of generating a file consisting of data and a first file name of the file;
a file name identification step of identifying a second file name that is different from the first file name corresponding to a predetermined transfer destination to which the file generated in the file generation step is transferred; and
a addition step of adds the second file name determined in the file name determination step to the file as additional information.

14. A storage medium encoded with a computer-readable program that enables a file processing apparatus to execute:
a file generation function that generates a file consisting of data and a first file name of the file;
a file name identification function that identifies a second file name that is different from the first file name corresponding to a predetermined transfer destination to which the file generated by the file generation function is transferred; and
a addition function that adds the second file name identified by the file name identification function to the file as additional information.
